(19) United States
(12) Patent Application Publication
(10) Pub. No.: US 2002/0062664 A1
(43) Pub. Date: May 30, 2002

(54) Method and device for refining a glass melting

(76) Inventors: Stefan Schmitt, Stadecken-Eisheim (DE); Frank Karetta, Dittelsheim-Hessloch (DE); Rainer Eichholz, Mainz (DE)

Correspondence Address: Pauley Petersen Kinne & Erickson, Suite 365, 2800 W. Higgins Road, Hoffman Estates, IL, 60195, US

(21) Appl. No.: 09/990,763

(22) Filed: Nov. 9, 2001

(30) Foreign Application Priority Data
Nov. 11, 2000 (DE) 100 55 969.7-45

(51) Int. Cl. C03B 5/225

(52) U.S. Cl. 65/134.2; 65/157; 65/346

(57) ABSTRACT

A method and apparatus for refining a glass melting with a vacuum generated above a surface of a glass flux. Refinement is improved because the glass flux is conducted sequentially through several vacuum chambers, and the pressure in the successive vacuum chambers is reduced more and more relative the atmospheric pressure.

### BACKGROUND OF THE INVENTION

1. Field of the Invention

This invention relates to a method for refining a glass melting with a vacuum generated above the surface of a glass flux. This invention also relates to a device for executing this method.

2. Description of Related Art

Two different methods for refining a glass melting, which operate by a pressure above the glass flux which is reduced with respect to atmospheric pressure, are basically known.

With the first method, the glass flux is introduced from above into a container in which a reduced pressure prevails. In the process, the glass is expanded because of the abrupt pressure change and a volume of foam is generated. With the disintegration of the foam, a glass melting is again generated later in the method, but with a clearly reduced content of gasses and dissolved bubbles in comparison to the glass melting supplied to the container. Such a method is disclosed in European Patent References EP 0 231 518 B1 and EP O 253 188 A1.

The second method uses a portal-like underpressure apparatus as shown in U.S. Pat. No. 1,598,308 and European Patent Reference EP O 908 417. In this case the glass flux rises through a vertical ascending pipe into a horizontal refining bench. The vacuum is generated above the glass flux of the refining bench. The refined glass flux flows out of the underpressure apparatus through a vertical downpipe. With this method there is also a strong foam generation, in particular above the feed of the ascending pipe to the refining bench, and above the surface of the glass flux in the refining bench later in the direction toward the downpipe.

With both known methods, because of the present glass throughput flow, foam is again introduced into the glass flux. Therefore there is a considerable danger that foam or individual bubbles made of foam residue again enter into the product and result in losses in the yield or reduced quality of the product. Thus there have been many attempts to prevent this problem.

In connection with the method using the container, others have tried to bring the foam generation under better control by using oxygen burners or plasma burners, as well as combustion of oil with an increased portion of water, as shown in U.S. Pat. No. 4,704,153.

Methods with portal-like underpressure apparatus provide foam barriers in the refining bench, which prevent the foam carpet generated in the refining bench from moving as far as the downpipe, as shown in European Patent Reference EP 0 755 671 A1.

However, it has been shown that, depending on the glass composition, these additional steps do not always lead to a sufficient refinement of the glass melting.

### SUMMARY OF THE INVENTION

It is one object of this invention to provide a method of the type mentioned above but which results in improved refinement and can be adapted more efficiently to the glass composition used. It is a further object of this invention to disclose a device for executing the method of this invention.

The method of this invention is distinguished because the glass flux is sequentially conducted through several vacuum chambers, and the pressure in the successive vacuum chambers is more and more reduced in comparison with the atmospheric pressure.

The step-by-step reduction of the pressure in the vacuum chambers results in an improved refinement, wherein in the first stage a reduction to a pressure down to approximately 100 mbar below the pressure, at which the first foam formation starts, is performed. Thus, the greatest foam volume is generated in the first stage. This pressure in the first stage lies in the range between 600 and 300 mbar. In the second and successive stages the pressure is selected so that the best refinement result is achieved.

The range, in particular of the end stage, is approximately between 300 and 30 mbar. The foam carried from the first stage is removed in the subsequent stages. Often two stages are sufficient for achieving a considerably more efficient solution, because in these stages the volume of foam generated is considerably smaller. Thus, the danger of foam or foam residue being entrained in the product is minimized or practically prevented.

A first device for executing the method is distinguished because the vacuum chambers are designed as a horizontal refining bench, wherein the glass flux from an inlet basin can be conducted to the first vacuum chamber via an inlet ascending pipe. The respectively following vacuum chamber has the incoming glass flux via an intermediate ascending pipe adjoining the end. of the previous refining bench. The last vacuum chamber conducts the glass flux to an outlet basin via a downpipe.

An expanded portal-like underpressure apparatus, or several refining benches through which the glass flux successively flows, are used with this device. Thus it is possible to further reduce the entrainment of foam or foam residue in a simple manner in that the wall toward a subsequent vacuum chamber, which is in front in the direction of flow of the glass flux, of the intermediate ascending pipe partially extends into the glass flux of the previous refining bench.

In a second device for executing the method in accordance with this invention, the vacuum chambers are arranged vertically above each other in a multi-chamber housing. The glass flux can be conducted through a ceiling inlet to the uppermost vacuum chamber and enters the following vacuum chamber via a bottom outlet. The refined glass flux exits through a bottom outlet of the lowermost vacuum chamber, and every vacuum chamber is connected with an individual vacuum pump above the received glass flux.

The container is formed as a multi-chamber container, wherein the glass flux flows sequentially through the vacuum chambers and is exposed to different pressures, so that the foam formation is also reduced from stage to stage and the refinement is improved. For generating the different pressures in the vacuum chambers the vacuum chambers have connecting openings for the vacuum pumps in the lateral walls of the multi-chamber housing.

In one embodiment, for structural reasons and reasons connected with heat technology, the vacuum chambers are combined in a modular unit.

### BRIEF DESCRIPTION OF THE DRAWINGS

This invention is explained in view of exemplary embodiments represented in the drawings, wherein:

FIG. 1 is a sectional view of a first embodiment of a device for executing a method in accordance with this invention, having two refining benches which are effective one after the other; and

FIG. 2 is a sectional view of a second embodiment of a device for executing the method in accordance with this invention, having a container with two vacuum chambers.

### DESCRIPTION OF PREFERRED EMBODIMENTS

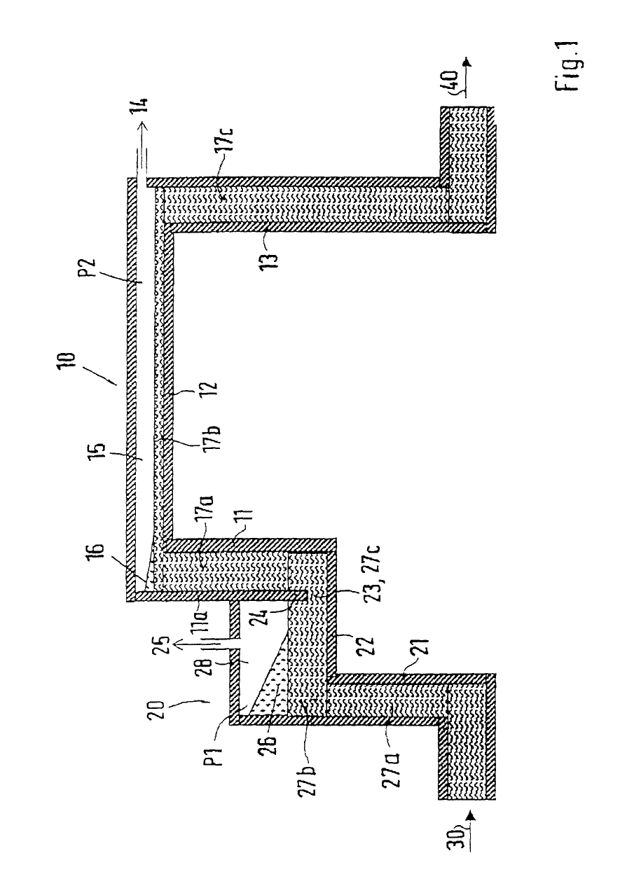

As shown in the sectional view in FIG. 1, the glass melting reaches the device for executing the method of this invention from an inlet basin 30. The glass flux 27a reaches a first horizontal refining bench 22 via a vertical inlet ascending pipe 21. The vacuum chamber 28 formed above the glass flux 27b of the refining bench 22 is at a pressure P1, which is generated by a vacuum pump 25. This pressure P1 lies approximately 100 mbar below the underpressure leading to foam generation in comparison to the atmospheric pressure and lies in the approximate range between 600 to 300 mbar. This results in a large foam volume 26, preferably above the inlet ascending pipe 21. The first refining bench 22 transitions into a vertical intermediate ascending pipe 11 of a second refining bench 12. In this case the wall 11a, which is in front in the flow direction, of the intermediate ascending pipe 11 partially projects into the glass flux 27b, which transitions into the intermediate ascending pipe 11. The already greatly refined glass flux 17a flows to the second refining bench 12 in the intermediate ascending pipe 11. Foam formation again occurs above the intermediate ascending pipe 11, but at a considerably smaller foam volume 16.

In the second horizontal refining bench 12 a pressure P2 prevails above the surface in the vacuum chamber 15, which is still further reduced and generated by the vacuum pump 14. It is possible to attach further refining benches in the same way with intermediate ascending pipes at the end of the second refining bench 12. However, in many cases a two-stage device as in the exemplary embodiment represented is sufficient for obtaining an excellent refinement of the glass melting. The refined glass flux 17c then flows out of the last refining bench 12 via a downpipe 13 into an outlet basin 40 for further processing. The pressure in the end stage is selected to be approximately 300 to 30 mbar.

In an exemplary embodiment with more than two stages the pressure can be reduced in stages, wherein as large as possible a foam volume is intended to be achieved in the first stage, and in the following stages the refinement is improved and the entrainment of foam or foam residue into the downpipe which ends the device is preferably prevented.

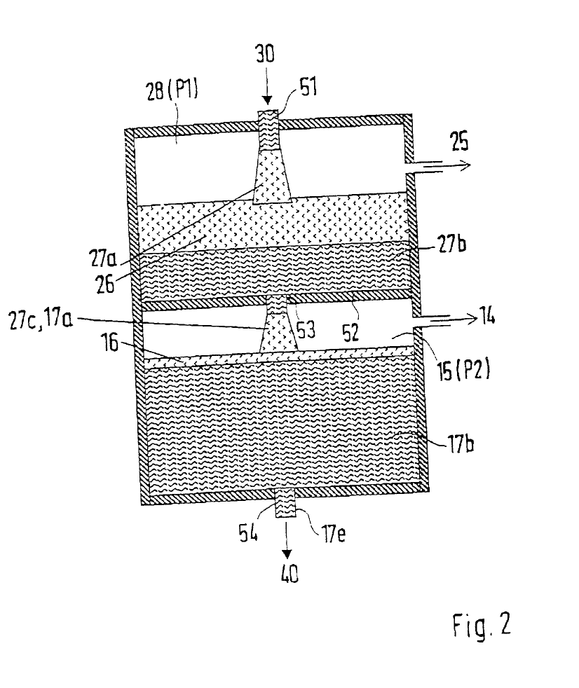

FIG. 2 shows an exemplary embodiment with a multi-chamber housing 50 having two vacuum chambers 28 and 15. The vacuum chambers 28 and 15 are arranged vertically above each other. The glass melting in the form of a glass flux 27a is conducted from the inlet basin 30 of the upper vacuum chamber 28 via a ceiling inlet 51. The vacuum pump 25 provides the pressure P1 above the glass flux 27b in the vacuum chamber 28. The foam generated therein has a large foam volume 26. The pre-refined glass flux 27c in the form of a fed-in glass flux 17a reaches the lower vacuum chamber 15, in which the reduced pressure P2 generated by the vacuum pump 14 prevails, via a bottom outlet 53 in the bottom 52 of the vacuum chamber 28. The refined glass melting reaches the outlet basin 40 through the bottom outlet 54 of the lower vacuum chamber 15.

With this type of a device the functions of foam generation and prevention of the entrainment of foam or foam residue in the product are distributed to the vacuum chambers 28 and 15 through which the flow passes serially, and the refinement is thus improved.

It is possible to provide the multi-chamber housing 50 with more than two vacuum chambers 28 and 15. The refining benches 22 and 12, and the vacuum chambers 28 and 15 are combined into one modular unit.

What is claimed is:

1. A method for refining a glass melting wherein a vacuum is generated above a surface of a glass flux, the method comprising:
conducting the glass flux (27b, 17b) sequentially through a plurality of successive vacuum chambers (28, 15), and
reducing the pressure (PI, P2) in the successive vacuum chambers (28, 15) relative to an atmospheric pressure.

2. In the method in accordance with claim 1, wherein each of the vacuum chamber (28, 15) is assigned an individual vacuum pump (25, 14).

3. In the method in accordance with claim 2, wherein the glass flux (27b, 17b) is conducted through two of the vacuum chambers (28, 15) wherein a first pressure (P1) in a first vacuum chamber (28) is selected in a first range of 600 mbar to 300 mbar, and a second pressure (P2) in the second vacuum chamber (15) is selected in a second range between 300 mbar and 30 mbar.

4. In the method in accordance with claim 1, wherein the glass flux (27b, 17b) is conducted through two of the vacuum chambers (28, 15) wherein a first pressure (P1) in a first vacuum chamber (28) is selected in a first range of 600 mbar to 300 mbar, and a second pressure (P2) in the second vacuum chamber (15) is selected in a second range between 300 mbar and 30 mbar.

5. In the method in accordance with claim 1, wherein a plurality of vacuum chambers (28, 15) designed as a horizontal refining bench (22, 12) wherein the glass flux (27a) from an inlet basin (30) is conducted to the first vacuum chamber (28) via an inlet ascending pipe (21), the incoming gas flux (17a) is provided to a respectively following vacuum chamber (15) of the vacuum chambers (28, 15) via an intermediate ascending pipe (11) adjoining an end of the previous refining bench (28), and a final vacuum chamber (15) of the vacuum chambers (28, 15) conducts the glass flux (17c) to an outlet basin (40) via a downpipe (13).

6. In the method in accordance with claim 5, wherein a wall (11a) which is in a front in a direction of flow of the glass flux (27b) of the intermediate ascending pipe (11) to the subsequent vacuum chamber (15) of the vacuum chambers (28,15) partially extends into the glass flux (27c) of the previous refining bench (22).

7. In the method in accordance with claim 1, wherein the vacuum chambers (28, 15) are arranged vertically above each other in a multi-chamber housing (50), the glass flux (27b) is conductable through a ceiling inlet (41) to the uppermost vacuum chamber (28) and enters the following vacuum chamber (15) via a bottom outlet (53), a refined glass flux (17c) exits through a bottom outlet (54) of the lowermost vacuum chamber (15), and each of the vacuum chambers (28, 15) is connected with an individual vacuum pump (25, 14) above the received glass flux (27b, 17b).

8. In the method in accordance with claim 7, wherein the vacuum chambers (28, 15) have connecting openings for the vacuum pumps (25, 14) in the lateral walls of the multi-chamber housing (50).

9. In an apparatus for refining a glass melting wherein a vacuum is generated above a surface of a glass flux, the improvement comprising:
a plurality of vacuum chambers (28, 15) designed as a horizontal refining bench (22, 12) wherein the glass flux (27a) from an inlet basin (30) is conducted to the first vacuum chamber (28) via an inlet ascending pipe (21),
a respectively following vacuum chamber (15) of the vacuum chambers (28, 15) being provided with the incoming glass flux (17a) via an intermediate ascending pipe (11) adjoining an end of the previous refining bench (28), and
a final vacuum chamber (15) of the vacuum chambers (28, 15) conducting the glass flux (17c) to an outlet basin (40) via a downpipe (13).

10. In the apparatus in accordance with claim 9, wherein a wall (11a) which is in a front in a direction of flow of the glass flux (27b) of the intermediate ascending pipe (11) to the subsequent vacuum chamber (15) of the vacuum chambers (28,15) partially extends into the glass flux (27c) of the previous refining bench (22).

11. In the apparatus in accordance with claim 9, wherein the vacuum chambers (28, 15) are arranged vertically above each other in a multi-chamber housing (50), the glass flux (27b) is conductable through a ceiling inlet (41) to the uppermost vacuum chamber (28) and enters the following vacuum chamber (15) via a bottom outlet (53), the refined glass flux (17c) exits through a bottom outlet (54) of the lowermost vacuum chamber (15), and each of the vacuum chambers (28, 15) is connected with an individual vacuum pump (25, 14) above the received glass flux (27b, 17b).

12. In the apparatus in accordance with claim 11, wherein the vacuum chambers (28, 15) have connecting openings for the vacuum pumps (25, 14) in the lateral walls of the multi-chamber housing (50).

13. In the apparatus in accordance with claim 12, wherein the vacuum chambers (28, 15) are combined in a modular unit.
